(19) United States
(12) Patent Application Publication
(10) Pub. No.: US 2024/0380936 A1
(43) Pub. Date: Nov. 14, 2024

(54) SERVER, METHOD AND COMPUTER PROGAM

(71) Applicant: 17LIVE Japan Inc., Tokyo (JP)

(72) Inventor: Wei-Kun LU, Taipei City (TW)

(21) Appl. No.: 18/490,244

(22) Filed: Oct. 19, 2023

(30) Foreign Application Priority Data
May 11, 2023 (JP) 2023-078817

(51) Int. Cl. H04N 21/266; H04N 21/2187; H04N 21/278

(52) U.S. Cl. CPC H04N 21/26603; H04N 21/2187; H04N 21/278

(57) ABSTRACT

A server for managing streams in a live streaming platform, comprising one or a plurality of processors, wherein the one or plurality of processors execute a machine-readable instruction to perform: receiving a first stream from a user terminal of a user; determining whether the first stream satisfied a first category; and adding the first stream into the first category in response to the first stream matching the first category. According to the embodiments, it is easier to generate and maintain the category of the stream. Moreover, the category of streams may be added, updated, modified or removed dynamically without complicated procedure. Therefore, the quality of streams in the live streaming platform may be improved.

### CROSS-REFERENCE TO RELATED APPLICATIONS

This application is based on and claims the benefit of priority from Japanese Patent Application Serial No. 2023-078817 (filed on May 11, 2023), the contents of which are hereby incorporated by reference in its entirety.

### TECHNICAL FIELD

This disclosure relates to information and communication technology, and in particular, to a server, method and computer program in a live streaming.

### BACKGROUND

Some APPs or platforms provide live streaming service for streamers and viewers to interact with each other. The streamers may have a performance to cheer up the viewer and the viewer may send gifts to support the streamers.

In order to let the viewers access to the streamers they are interested in, streams are always classified into different categories so that the viewer may focus on the category they are interested in. Patent Document 1 disclose a method to classify streams into different categories according to their feature indexes.

However, with the increase of the streams, it becomes more and more difficult to maintain the category of the streams. Moreover, complicated procedures are always necessary in order to manage the category while the stream is updated or closed. Therefore, how to manage the category of the stream in a more efficient and effective way is a very important issue.

### [Patent Document 1]: CN114268839A

### SUMMARY

An embodiment of subject application relates to a server for managing streams in a live streaming platform, comprising one or a plurality of processors, wherein the one or plurality of processors execute a machine-readable instruction to perform: receiving a first stream from a user terminal of a user; determining whether the first stream satisfied a first category; and adding the first stream into the first category in response to the first stream matching the first category.

Another embodiment of subject application relates to a method for managing streams in a live streaming platform, comprising: receiving a first stream from a user terminal of a user; determining whether the first stream satisfied a first category; and adding the first stream into the first category in response to the first stream matching the first category.

Another embodiment of subject application relates to a computer program for causing a server to realize the functions of: receiving a first stream from a user terminal of a user; determining whether the first stream satisfied a first category: and adding the first stream into the first category in response to the first stream matching the first category.

According to the embodiments, it is easier to generate and maintain the category of the stream. Moreover, the category of streams may be added, updated, modified or removed dynamically without complicated procedure. Therefore, the quality of streams in the live streaming platform may be improved.

### BRIEF DESCRIPTION OF THE DRAWINGS

FIG. 1 is a schematic configuration of a live streaming system 1 according to some embodiments of subject application;

FIG. 2 is a schematic block diagram of the user terminal 20 according to some embodiments of subject application:

FIG. 3 is a schematic block diagram of the server 10 according to some embodiments of subject application;

FIG. 4 shows an exemplary data structure of the stream DB 320 of FIG. 3;

FIG. 5 shows an exemplary data structure of the user DB 322 of FIG. 3;

FIG. 6 shows an exemplary data structure of the filter DB 324 of FIG. 3;

FIG. 7 shows an exemplary data structure of the category DB 326 of FIG. 3;

FIG. 8 is exemplary functional configuration of the live streaming system 1 according to some embodiments of subject application;

FIG. 9 and FIG. 10 are exemplary screen images of a live-streaming room screen 600 shown on the display of the viewer user terminal 30;

FIG. 11-FIG. 13 are exemplary sequence charts illustrating operations of the configuration of the live streaming system I according to some embodiments of subject application;

FIG. 14 is an exemplary hardware configuration of the information processing device according to some embodiments of subject application.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

The live streaming system 1 according to some embodiments of subject application provides enhancement among the users to communicate and interact smoothly. More specifically, it entertains the viewers and streamers in a technical way.

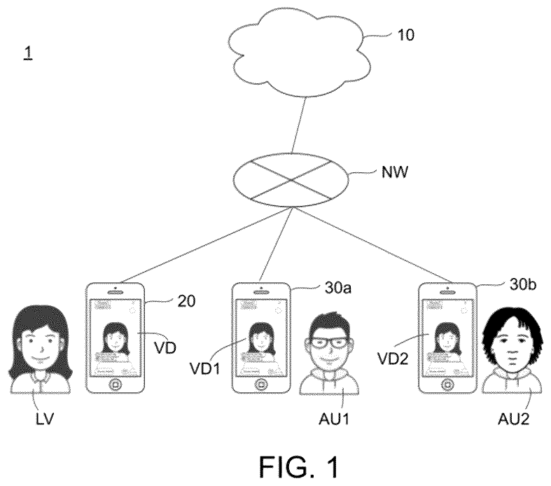

FIG. 1 shows a schematic configuration of a live streaming system 1 according to some embodiments of subject application. The live streaming system 1 provides a live streaming service for the streaming streamer (may also be referred as live or streamer) LV and viewer (may also be referred as audience) AU (AU1, AU2 . . . ) to interact mutually in real time. As shown in FIG. 1, the live streaming system 1 may include a server 10, a user terminal 20 and a user terminal 30 (30a, 30b . . . ). The user terminal 20 may be a streamer and the user terminal 30 may be a viewer. In some embodiments, the streamers and viewers may be referred to as the user.

The server 10 may include one or a plurality of information processing devices connected via network NW. The user terminal 20 and 30 may be, for example, a portable terminal such as the smartphone, tablet, laptop PC, recorder, mobile game console, wearable device or the like, or the stationary computer such as desktop PC. The server 10, user terminal 20 and user terminal 30 may be communicably connected by any type of wire or wireless network NW.

The live streaming system 1 is involved in the streamer LV, the viewer AU, and APP provider (not shown), who provides the server 10. The streamer LV may record his/her own contents such as songs, talks, performance, game streaming or the like by his/her own user terminal 20 and upload to the server 10 and be the one who distributes contents in real time. In some embodiments, the streamer LV may interact with the viewer AU via the live streaming.

The APP provider may provide a platform for the contents to go on live streaming in the server 10. In some embodiments, the APP provider may be the media or manager to manage the real time communication between the streamer LV and viewer AU. The viewer AU may access the platform by the user terminal 30 to select and watch the contents he/she would like to watch. The viewer AU may perform operations to interact with the streamer, such as commenting or cheering the streamer, by the user terminal 30. The streamer, who provides the contents, may respond to the comment or cheer. The response of the streamer may be transmitted to the viewer AU by video and/or audio or the like. Therefore, a mutual communication among the streamer and viewer may be accomplished.

The “live streaming” in this specification may be referred to as the data transmission which enables the contents the streamer LV recorded by the user terminal 20 to be substantially reproduced and watched by the viewer AU via the user terminal 30, In some embodiments, the “live streaming” may also refer to the streaming which is accomplished by the above data transmission. The live streaming may be accomplished by the well-known live streaming technology such as HTTP Live Streaming, Common Media Application Format, Web Real-Time Communications, Real-Time Messaging Protocol, MPEG DASH or the like.

The live streaming may further include the embodiment that the viewer AU may reproduce or watch the contents with specific delay while the streamer is recording the contents. Regarding the magnitude of the delay, it should be at least small enough to enable the streamer LV and the viewer AU to communicate. However, live streaming is different from so-called on-demand streaming. More specifically, the on-demand streaming may be referred to as storing all data, which records the contents, in the server and then providing the data from the server to the user at random timing according to the user's request.

The “streaming data” in this specification may be referred to as the data includes image data or voice data. More specifically, the image data (may be referred to as video data) may be generated by the image pickup feature of the user terminal 20 and 30. The voice data (may be referred to as audio data) may be generated by the audio input feature of the user terminal 20 and 30. The streaming data may be reproduced by the user terminal 20 30, so that the contents relating to users may be available for watching. In some embodiments, during the period from the streaming data being generated by the user terminal of the streamer to being reproduced by the user terminal of the viewer, the processing of changing format, size, or specification of the data, such as compression, extension, encoding, decoding, transcoding or the like, is predictable. Before and after this kind of processing, the contents (such as video and audio) are substantially unchanged, so it is described in the current embodiments of the present disclosure that the streaming data before being processed is the same as that after being processed. In other words, if the streaming data is generated by the user terminal of the streamer and reproduced by the user terminal of the viewer via the server 10, the streaming data generated by the user terminal of the streamer, the streaming data passed through the server 10 and the streaming data received and reproduced by the by the user terminal of the viewer are all the same streaming data.

As shown in FIG. 1, the streamer LV is providing the live streaming. The user terminal 20 of the streamer generates the streaming data by recording his/her video and/or audio, and transmits to the server 10 via the network NW. At the same time, the user terminal 20 may display the video VD on the display of the user terminal 20 to check the streaming contents of the streamer LV.

The viewer AU1, AU2 of the user terminal 30a, 30b, who request the platform to provide the live streaming of the streamer, may receive streaming data corresponding to the live streaming via the network NW and reproduce the received streaming data to display the video VD1, VD2 on the display and output the audio from a speaker or the like. The video VD1, VD2 displayed on the user terminal 30a, 30b respectively may be substantially the same as the video VD recorded by the user terminal of the streamer LV, and the audio outputted from the terminal 30a, 30b may also be substantially the same as the audio recorded by the user terminal of the streamer LV.

The recording at the user terminal 20 of the streamer may be simultaneous with the reproducing of the streaming data at the user terminal 30a, 30b of the viewer AU1, AU2. If a viewer AU1 inputs a comment on the contents of the streamer LV into the user terminal 30a, the server 10 will display the comment on the user terminal 20 of the streamer in real time, and also display on the user terminal 30a, 30b of the viewer AU1, AU2 respectively. If the streamer LV responds to the comment, the response may be outputted as the text, image, video or audio from the terminal 30a, 30b of the viewer AU1, AU2, so that the communication of the streamer LV and viewer LV may be realized. Therefore, the live streaming system may realize the live streaming of two-way communication.

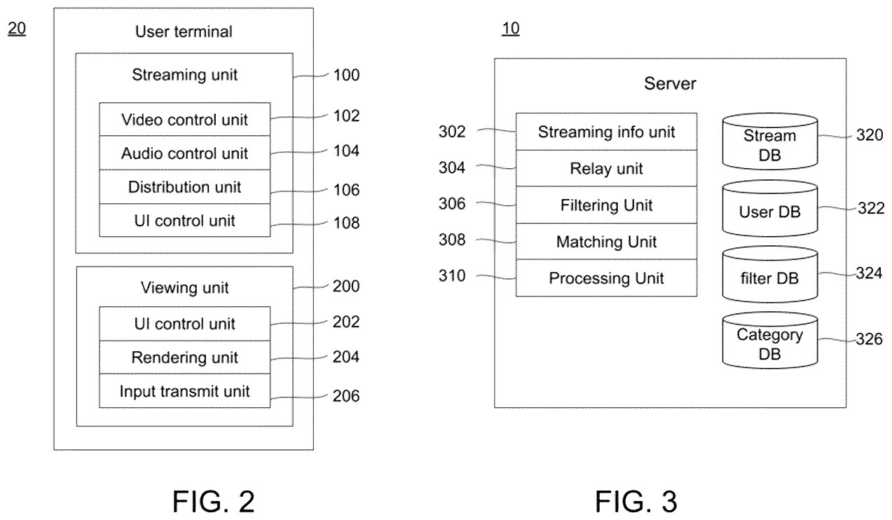

FIG. 2 is a block diagram showing a function and configuration of the user terminal 20 in FIG. 1 according to the embodiment of the present disclosure. The user terminal 30 has the similar function and configuration of the user terminal 20. The blocks depicted in the block diagram of this specification are implemented in hardware such as devices like a CPU of a computer or mechanical components, and in software such as a computer program depicts functional blocks implemented by the cooperation of these elements. Therefore, it will be understood by those skilled in the art that the functional blocks may be implemented in a variety of manners by a combination of hardware and software.

The streamer LV and viewer AU may download and install the live streaming application (live streaming APP) of the present disclosure to the user terminal 20 and 30 from the download site via network NW. Or the live streaming APP may be pre-installed in the user terminal 20 and 30. By the execution of the live streaming by the user terminal 20 and 30, the user terminals 20 and 30 may communicate with the server 10 via the network NW to realize a plurality of functions. The functions realized by the execution of the live streaming APP by the user terminal 20 and 30 (More specifically, the processor such as CPU) is described below as the functions of the user terminal 20 and 30. These functions are basically the functions that the live streaming APP makes the user terminals 20 and 30 realize. In some embodiments, these functions may also be realized by transmitting from the server 10 to the web browser of the user terminal 20 and 30 via network NW and be executed by the computer program of the web browser. The computer program may be written in the programming language such as HTML (Hyper Text Markup Language) or the like.

The user terminal 20 includes streaming unit 100 and viewing unit 200. In some embodiments, the streaming unit 100 is configured to record the audio and/or video data of the user and generate streaming data to transmit to the server 10. The viewing unit 200 is configured to receive and reproduce streaming data from server 10. In some embodiments, a user may activate the streaming unit 100 when broadcasting or activate the viewing unit 200 when watching streaming respectively. In some embodiments, the user terminal who is activating the streaming unit 100 may be referred to as an streamer or be referred to as the user terminal which generates the streaming data. The user terminal who is activating the viewing unit 200 may be referred to as an viewer or be referred to as the user terminal which reproduces the streaming data.

The streaming unit 100 may include video control unit 102, audio control unit 104, distribution unit 106 and UI control unit 108. The video control unit 102 may be connected to a camera (not shown) and the video is controlled by the camera. The video control unit 102 may obtain the video data from the camera. The audio control unit 104 may be connected to a microphone (not shown) and the audio is controlled by the microphone. The audio control unit 104 may obtain the audio data from the microphone.

The distribution unit 106 receives streaming data, which includes video data from the video control unit 102 and audio data from the audio control unit 104, and transmits to the server 10 via network NW. In some embodiments, the distribution unit 106 transmits the streaming data in real-time. In other words, the generation of the streaming data from the video control unit 102 and audio control unit 104, and the distribution of the distribution unit 106 is performed simultaneously.

UI control unit 108 controls the UI for the streamer. The UI control unit 108 is connected to a display (not shown) and is configured to generate the streaming data to whom the distribution unit 106 transmits, reproduces and displays the streaming data on the display. The UI control unit 108 shows the object for operating or the object for instruction-receiving on the display and is configured to receive the tap input from the streamer.

The viewing unit 200 may include UI control unit 202, rendering unit 204 and input transmit unit 206. The viewing unit 200 is configured to receive streaming data from server 10 via network NW. The UI control unit 202 controls the UI for the viewer. The UI control unit 202 is connected to a display (not shown) and/or speaker (not shown) and is configured to display the video on the display and output the audio from the speaker by reproducing the streaming data. In some embodiments, Outputting the video on the display and audio from the speaker may be referred to as “reproducing the streaming data”. The UI control unit 202 may be connected to an input unit such as touch panel, keyboard or display or the like to obtain input from the users.

The rendering unit 204 may be configured to render the streaming data from the server 10 and the frame image. The frame image may include user interface objects for receiving input from the user, the comments inputted by the viewers and the data received from the server 10. The input transmit unit 206 is configured to receive the user input from the UI control unit 202 and transmit to the server 10 via the network NW.

In some embodiments, the user input may be clicking an object on the screen of the user terminal such as selecting a live stream, entering a comment, sending a gift, following or unfollowing an user, voting in an event, gaming or the like. For example, the input transmit unit 206 may generate gift information and transmit to server 10 via the internet NW if the user terminal of the viewer clicks a gift object on the screen in order to send a gift to the streamer.

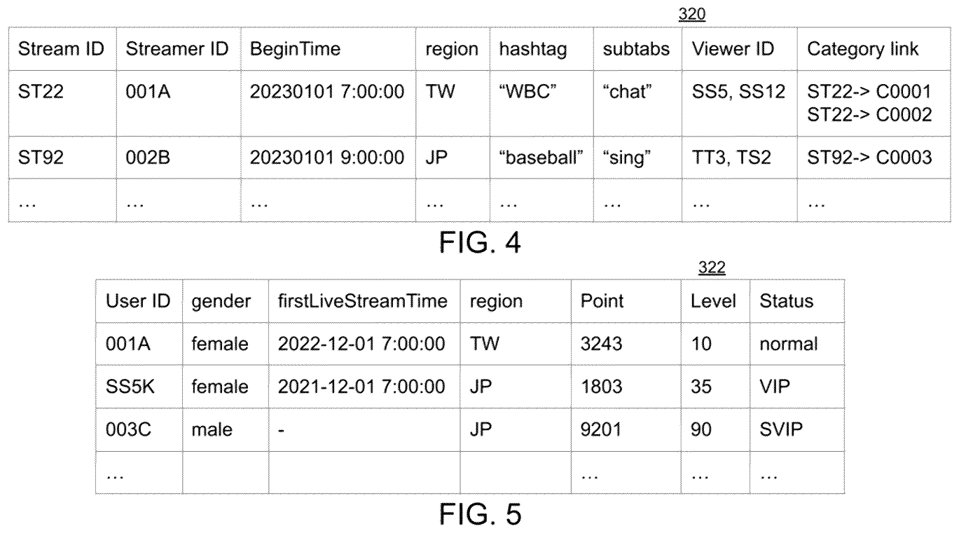

FIG. 3 is a schematic block diagram of the server 10 according to some embodiments of the subject application. The server 10 may include streaming info unit 302, relay unit 304, filtering unit 306, matching unit 308, processing unit 310, stream DB 320, user DB 322, filter DB 324 and category DB 326.

The streaming info unit 302 receives the request of live streaming from the user terminal 20 of the streamer via the network NW. Once receiving the request, the streaming info unit 302 registers the information of the live streaming on the stream DB 320. In some embodiments, the information of the live streaming may be the stream ID of the live streaming and/or the streamer ID of the streamer corresponding to the live streaming.

Once receiving the request of providing the information of the live streaming from the viewing unit 200 of the user terminal 30 from the viewer via the network NW, the streaming info unit 302 refers to the stream DB 320 and generates a list of the available live streaming.

The streaming info unit 302 then transmits the list to the user terminal 30 via the network NW. The UI control unit 202 of the user terminal 30 generates a live streaming selection screen according to the list and displays the list on the display of the user terminal 30.

Once the input transmit unit 206 of the user terminal 30 receives the selection of the live streaming from the viewer on the live streaming selection screen, it generates the streaming request including the stream ID of the selected live streaming and transmits to the server 10 via the network. The streaming info unit 302 may start to provide the live streaming, which is specified by the stream ID in the streaming request, to the user terminal 30. The streaming info unit 302 may update the stream DB 320 to add the viewer's viewer ID of the user terminal 30 to the streamer ID of the stream ID.

The relay unit 304 may relay the transmission of the live streaming from the user terminal 20 of the streamer to the user terminal 30 of the viewer in the live streaming started by the streaming info unit 302. The relay unit 304 may receive the signal, which indicates the user input from the viewer, from the input transmit unit 206 while the streaming data is reproducing. The signal indicating the user input may be the object-designated signal which indicates the designation of the object shown on the display of the user terminal 30. The object-designated signal may include the viewer ID of the viewer, the streamer ID of the streamer, who delivers the live streaming the viewer is viewing, and object ID specified by the object. If the object is a gift or the like, the object ID may be the gift ID or the like. Similarly, the relay unit 304 may receive the signal indicating the user input of the streamer, for example the object-designated signal, from the streaming unit 100 of the user terminal 20 while the streaming data is reproducing.

The filtering unit 306 is configured to filter the raw stream by category. More specifically, the filtering unit 306 may determine whether a raw stream matches a category or the like. The filtering unit 306 may include a plurality of filters. Each filter F may include, for example, the category and mapping function for mapping the raw stream with the corresponding category.

The matching unit 308 is configured to match the raw stream to the corresponding category in category DB 326. The matching unit 308 may add, update, modify or remove the raw stream from the category in category DB 326 according to the output from the filtering unit 306. In some embodiments, the output may be a match list or the like. Once a raw stream is filtered by a corresponding category, the filtering unit 306 may retrieve the information in filter F such as “category” and “filter ID”, and then generate a match between the raw stream and the category. The matching unit 308 may further generate a corresponding category and add the raw stream to the category according to the match between the raw stream and the category.

The processing unit 310 is configured to provide the user with streams according to the category of the stream. In response to the request of streams from the viewer, the processing unit 310 may retrieve streams and collect the streams with specific categories, and then provide the user with the stream dynamically.

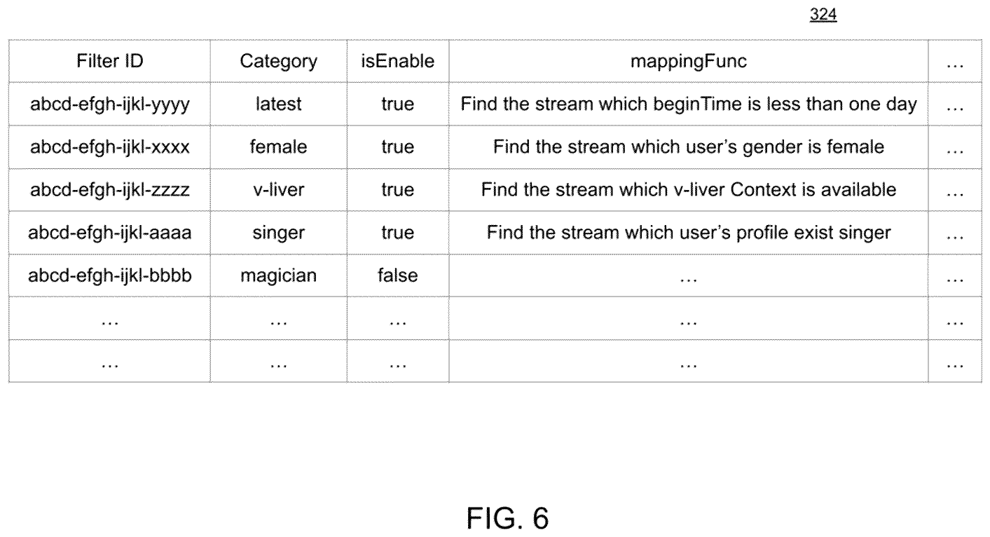

FIG. 4 shows an exemplary data structure of the stream DB 320 of FIG. 3. The stream DB 320 holds information regarding a live stream currently taking place. The stream DB 320 stores a stream ID for identifying a live-stream on a live distribution platform provided by the live-streaming system 1, a streamer ID for identifying the streamer who provides the live-stream, and a viewer ID for identifying a viewer of the live-stream, in association with each other.

In some embodiments, the stream DB 320 may also store “BeginTime” for identifying the time the streamer begins the stream, region for identifying the region the stream belongs to, hashtag for identifying the category of the stream and subtabs for identifying the subcategory of the stream, in association with each other. In some embodiments, the hashtag and subtabs may be set by the user or determined by the server 10. manually or automatically. The server 10 may determine the hashtag and subtabs by any possible technology such as machine learning, AI tagging or the like.

In some embodiments, the stream DB 320 may also store a category link for identifying a raw stream with its corresponding category. More specifically, the category link may be a parameter indicating the raw stream in stream DB 320 and its category in the category DB 326. The category link may be a linked list in format and includes a sequence of nodes that are linked to each other. In some embodiments, the category link may be a data structure that links the stream to the category by parameters such as stream ID, category ID or the like.

In some embodiments, the stream of the stream ID may refer to the category of the category ID in the category DB 326 according to the category link. In some embodiments, the category link may include information of order of the stream at the category in the category DB 326. For example, the category link may show that the stream is the first one or second one in the category. In some embodiments, the order of streams in each category may be rearranged, reordered, or inserted with other streams according to the category link. According to embodiments, the category, order or layout of streams in each category may be maintained easily.

The category link may be any kind of linked list object such as singly linked list, doubly linked list, multiply linked list or the like. For example, the category link may singly link the stream ID to the category ID. The category link may doubly link the stream ID to the category ID and the category ID to the stream ID mutually. In embodiments the category link may also multiply link the stream ID to different nodes in the same category, different categories or the like. In some embodiments, the configuration of category link may be designed and set according to the practical need.

Once the matching unit 308 matches a raw stream to a corresponding category in the category DB 326, the filtering unit 306 may generate a category link according to the match of stream in stream DB 320 and category DB 326. The filtering unit 306 may further store the category link at the stream in stream DB 320. In some embodiments, the filtering unit 306 or the matching unit 308 may refer to the category of the stream according to the category link.

In some embodiments, if a stream belongs to more than one category, the stream may include one category link linking to more than one category, or more than one category link linking to a different category respectively. In some embodiments, the category of a stream may be identified, confirmed or referred to according to the category link.

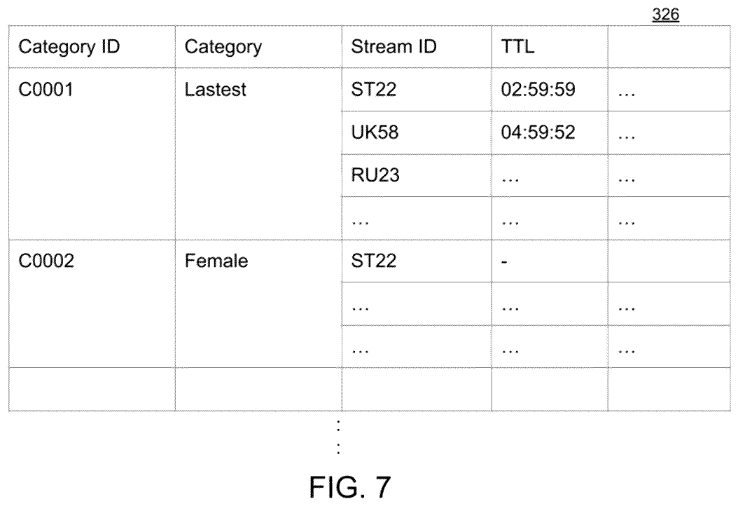

FIG. 5 shows an exemplary data structure of the user DB 322 of FIG. 3. The user DB 322 holds information regarding users. The user DB 322 stores a user ID for identifying a user, points that the user has, the level of the user and the status of the user in association with each other. The point is the electronic value circulated within the live-streaming platform. The level is an indicator of the amount of user activity or engagement on the live streaming platform. The status is an identity or membership status of the user on the live streaming platform.

In some embodiments, the user DB may also store gender for identifying the gender of the user, “firstLiveStreamTime” for identifying the first time of the user to start a live stream and region for identifying the region of the user, in association with each other. In some embodiments, each parameter of the user may be used to categorize the stream according to the attribute of the parameter. For example, a “female” category may be used to store the stream with the gender “female”. A “Level 80 up” category may be used to store the stream with the level over 80 or the like.

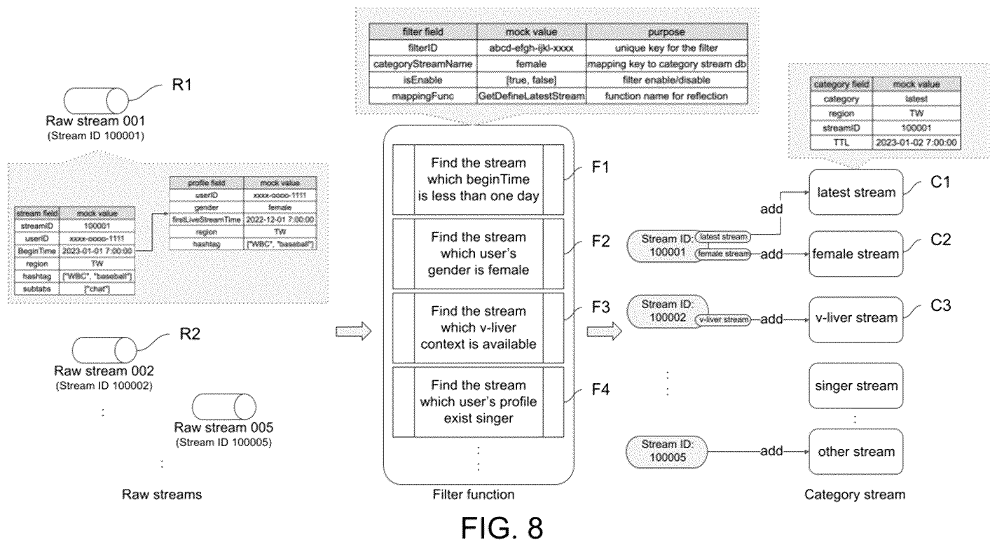

FIG. 6 shows an exemplary data structure of the filter DB 324 of FIG. 3. The filter DB 324 holds information regarding a filter F in the server 10. The filter DB 324 stores a filter ID for identifying a filter in the server 10, a category for identifying the category of the filter, a “isEnable” parameter for identifying enablement of the filter, and a “mappingFunc” function for identifying the function of mapping a stream to a corresponding category, in association with each other.

In some embodiments, the parameter of “mappingFunc” may be used to define the stream with specific features, and may be realized by coding a function in server 10. The features may be a specific category, a specific user list, a specific time period, a specific region or the like. For example, a list of users with user ID may be generated. In the mapping function, the parameter of “user ID” may be used as an indicator to determine whether the user in the stream matches the user ID in the list. In some embodiments, other parameters such as hashtag, user information, time information, region information may also be used as a parameter to determine whether the stream matches the category or not.

In some embodiments, the filter function may be realized by a service and framework such as RESTful API or gRPC framework, and may be coded by a programming language such as Golang or the like. The logic of programming may allow the server 10 to, for example, register a filter or retrieve the available filter list in server 10. In some embodiments, the filter function may be realized by any possible means according to the practical need.

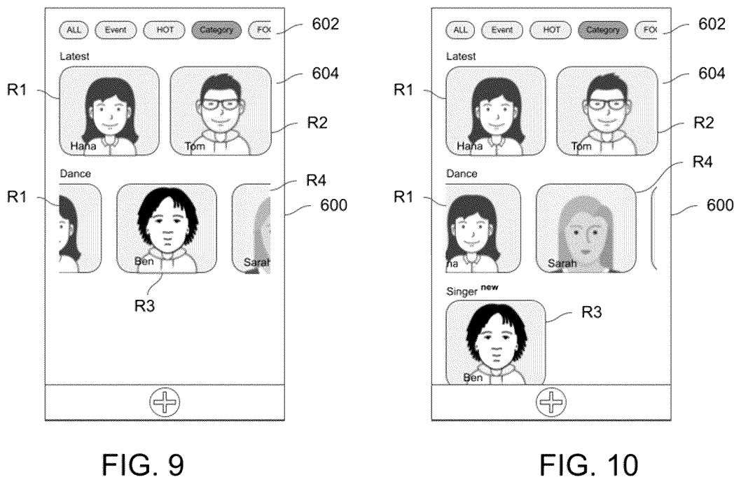

FIG. 7 shows an exemplary data structure of the category DB 326 of FIG. 3. The category DB 326 holds information regarding a category of the stream in the server 10. The category stores a category ID for identifying a category. a category for identifying a category in the server 10, a stream ID for identifying the stream belonging to the category, in association with each other.

In some embodiments, the category DB 326 may also store a TTL (time to live) for identifying the lifespan or lifetime of the stream at a category in category DB 326. For example, if there is a category called “latest” and it contains the stream broadcasting within the last 6 hours, a “TTL” may be set to the stream so that it would be removed from the category once the broadcasting time is over 6 hours.

In some embodiments, the format of the TTL may be a timestamp to indicate the time point for removing the stream from the category, or a time span to indicate the remaining time for the stream to be in the category or the like. In some embodiments, once a stream is removed from a category according to the TTL, the category link of the stream may also be updated dynamically, for example, be removed from the stream or the like.

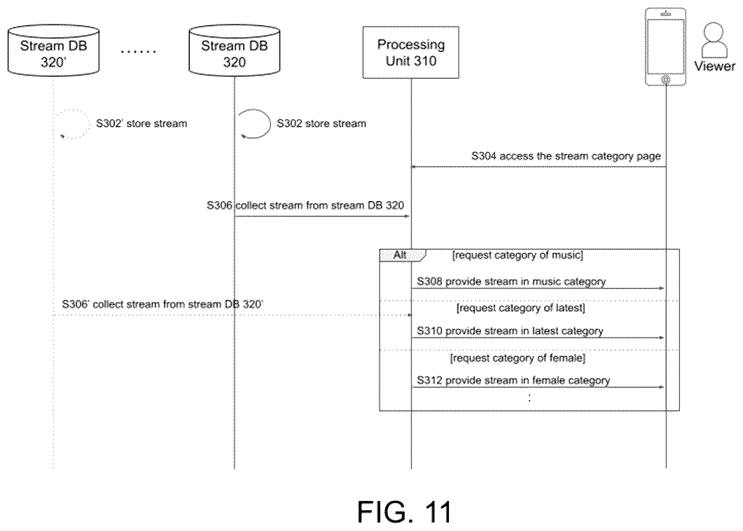

FIG. 8 is exemplary functional configuration of the live streaming system 1 according to some embodiments of subject application. As shown in FIG. 8, there may be a plurality of raw streams (R1, R2 . . . ) generated in server 10. Each raw stream may include information such as stream ID, user ID, stream begin time, region, other metadata or the like. In some embodiments, the metadata may include the data the streamer set before or during the broadcasting. For example, the metadata may include the setting of stream for army, the topic in the streaming room or the like.

The filtering unit 306 may filter each raw stream with each filter F to determine whether the raw stream matches a category of the filter F. In some embodiments, the filtering unit 306 may also refer to the information related to the stream. For example, the filtering unit 306 may refer to the user DB 322 to retrieve the profile of the streamer according to the user ID (or streamer ID) in the stream information. The filtering unit 306 may retrieve information such as gender or region of the streamer from the user DB 322. The information may further be used to filter and match the stream to the corresponding category.

Once a stream is generated by a streamer, an event checkpoint may be embedded. In the checkpoint, the information of the raw stream may be recorded and transmitted to the filtering unit 306. The filtering unit 306 may include one or more filters F that may be used for filtering streams by categories. The filters F may be generated in advance or in real-time. For example, there may be a default filter for the category of female and the stream with female streamer may be filtered and categorized into female stream. In some embodiments, a filter with v-liver may be generated in real-time when a category for v-live would like to be added on the category page.

In some embodiments, the raw streams may be hooked to the filter function so that the filter F may filter the raw streams once a raw stream is generated. Here, the “hook” may be referred to as a method to receive or be notified of changes in an API's status dynamically. It may be realized by any possible method such as webhook, polling, long-polling, real-time streaming or the like. In some embodiments, the way of hooking the raw stream with the filtering function may be realized by, for example, the framework of gRPC and the method of long-polling or any other possible means.

According to the embodiments, restart, reboot or reconfiguration of the server 10 is not necessary once a filter F is newly generated. In other words, if a new filter F for a category is generated, the filter may be able to work without extra configuration or setting. Moreover, the method of long-polling may also reduce the load on API servers because the API only needs to respond to the client's request when the resource's state changes.

As shown in FIG. 8, the filter function may include a plurality of filters (F1, F2 . . . ). Once a raw stream R1 is generated, the filtering unit 306 may filter the raw stream R1 with the filters F one by one. If the raw stream R1 matches a category, the matching unit 308 may add the raw stream R1 into the corresponding category in the category DB 326.

In some embodiments, one raw stream may match one or more than one category. As shown in FIG. 8, the raw stream R1 with stream ID “100001” matches the category of “latest stream” and “female stream”. Therefore, the matching unit 308 may add the information of the raw stream RI into the matched categories respectively.

In some embodiments, the matching unit 308 may not add a raw stream into any categories if the raw stream does not match to any categories. In some embodiments, the matching unit 308 may add raw streams into an “other category” if the raw stream does not match to any categories. In some embodiments, a filter F with the category of “other” may also be generated to filter the streams which are not matched to any category. According to the embodiment, the streams may be managed and maintained in an appropriate manner.

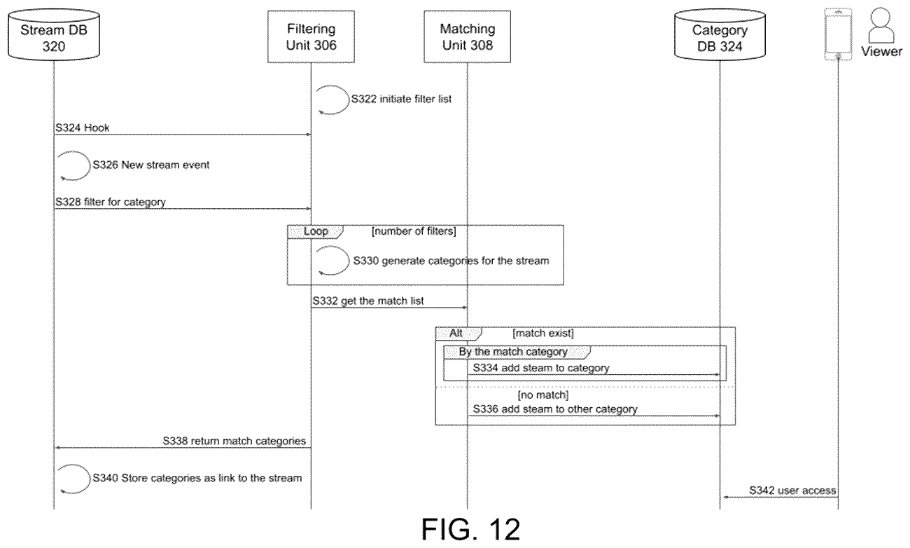

FIG. 9 and FIG. 10 are exemplary screen images of a live streaming selection screen 600 shown on the display of the viewer user terminal 30. The server 10 may provide a live streaming selection screen 600 for the viewer to select the streamer to watch. The live streaming selection screen 600 may include tab object 602 for the viewer to adjust the arrangement and layout of the stream. The live streaming selection screen 600 may also include the display zone 604 to display the streams for the viewer.

In some embodiments, the tab object 602 may include an “all” tab, “category” tab or the like for the viewer. The “all” tab may be used to display all streams and the “category” tab may be used to display streams classified by category. In some embodiments, the category of streams may include “latest”, “female”, “v-liver”, “singer” or the like, and the category may be added, removed, updated or modified by the server 10 flexibly according to practical need.

As shown in FIG. 9, there are categories of “latest” and “dance” in the live streaming selection screen 600. In the category of “latest”, there are at least two streams R1 and R2 available. In the category of “dance”, there are at least three streams R1, R3 and R4 available. The viewer may swipe right or left to check the other available stream.

In some embodiments, the filtering unit 306 and matching unit 308 may update the category DB 326 dynamically. The request of update may be based on the detection from server 10, from the administration staff, from the streamer or the viewer or the like. As shown in FIG. 9, the streamer “Ben” is categorized as the “dance” category. If the streamer would like to change his performance from dance to singing, the streamer may, for example, change the hashtag of the streaming room to update the topic of the streaming room.

Once an update is made in a raw stream, the filtering unit 306 and matching unit 308 may update the category DB 326 dynamically. In some embodiments, the update may be, for example, changing the name of the category, removing stream from one category, adding stream to another category, deleting stream or the like. As shown in FIG. 10, stream of the streamer “Ben” may be removed from the “dance” category and added to an newly generated “singer” category.

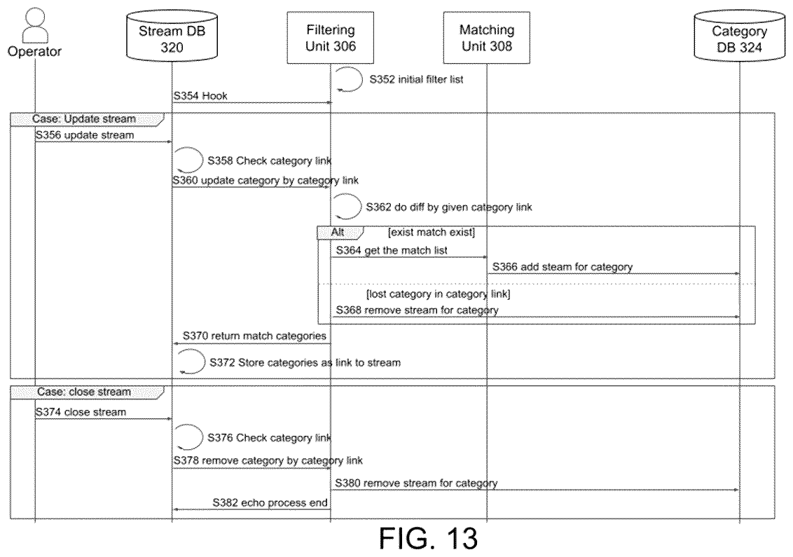

FIG. 11-FIG. 13 are exemplary sequence charts illustrating operations of the configuration of the live streaming system 1 according to some embodiments of subject application.

In some embodiments, server 10 may include a stream DB 320 which stores the live streams currently taking place. As shown in FIG. 11, once a streamer starts a live streaming, information of the stream may be stored in a database such as the stream DB 320 (S302). In some embodiments, the database may be an internal database in server 10 or a third-party database such as YAML, MangoDB, MySQL or the like. Viewers may access the stream category page via the user terminal 30 to select the live streaming (S304). The processing unit 310 may collect streams from the stream DB 320 (S306). If the viewer accesses the category page and, for example, requests the streams in the category of music, the processing unit 310 may provide the viewer with the streams in the music category (S308).

In some embodiments, if the viewer requests the streams in the category of latest, the processing unit 310 may provide the viewer with the streams in the latest category (S310). In some embodiments, if the viewer requests the streams in the category of female, the processing unit 310 may provide the viewer with the streams in the female category (S312). According to the embodiments, the processing unit 310 may provide the viewer with the streams category by category and the viewer may focus on the stream in the category he or she is interested in.

In some embodiments, the streams may be stored in the same database or different databases based on practical need. The processing unit 310 may need access to different databases to collect the information of streams. As shown in FIG. 11, another database such as stream DB 320′ may also be used to store stream (S302′). If a stream is stored in the stream DB 320′, the processing unit 310 may collect the stream from the stream DB 320′ (S306′). In some embodiments, each database has its technical logic, so the procedure for the processing unit 310 to collect streams and provide to the viewer may be different database by database.

FIG. 12 shows operations of the configuration of the live streaming system 1 in comparison with that shown in FIG. 11 as a related art. As shown in FIG. 12, the filtering unit 306 may initiate the list of filters in server 10 (S322). In some embodiments, there may be some default, newly generated, enabled or disabled filters F in server 10, and the filtering unit 306 may retrieve available filters by initiating the list of filters in server 10. In some embodiments, the filtering unit 306 may register all the filters in server 10 and provide a filter list for processing the filter function.

In some embodiments, the stream DB 320 may be booked to the filtering unit 306 (S324). By hooking the stream DB 320 to the filtering unit 306, a raw stream may be filtered and matched to the corresponding category once being generated or updated. Once a streamer starts a live streaming, information of the stream may be stored in the stream DB 320 (S326). Moreover, the information of the streams may be transmitted to the filtering unit 306 to filter for categories (S328).

The filtering unit 306 may generate categories for the stream by, for example, filtering the stream for the category (S330). In some embodiments, the filtering unit 306 may filter the stream filter F by filter F. In some embodiments, the filtering unit 306 may filter each stream S with each filter F in a loop. For example, if there are three filters F1, F2 and F3, the filtering unit 306 may filter the raw stream by filters F1, F2 and F3 respectively. The filtering unit 306 may filter each stream with each filter respectively to determine whether the stream matches the category in each filter F.

In some embodiments, if the gender of the streamer in stream R1 is female and the category of the filter F2 is female, the filtering unit 306 may match the stream R1 to the category of female by the filter F2. More specifically, the filter F2 may include a mapping function indicating that finding the stream which the streamer's gender is female. Since the gender of the streamer in stream R1 is female, the stream R1 may match to the category in filter F2. The filtering unit 306 may further retrieve, for example, the name of the category and filter ID in filter F2 and generate a match between the stream R1 and filter F2.

After filtering all streams with each filter F respectively, the filtering unit 306 may generate a match list and transmit the match list to the matching unit 308 (S332). In some embodiments, the match list may be an output from the filtering unit 306, such as a table or the like, showing the matching result between raw streams and filters F. The matching unit 308 may further match the raw streams to the category DB 324 according to the match list (S334). For example, if the stream R1 matches categories of “latest” and “female”, the matching unit 308 may add the stream RI to the categories of “latest” and “female” in category DB 324 respectively. In some embodiments, the information of the stream RI such as stream ID or the like may be added to the category DB 324 as reference. In some embodiments, if there is no corresponding category in category DB 324, the matching unit 308 may generate a new category and add the stream to the newly generated category.

In some embodiments, one stream may match no, one or more than one category. In some embodiments, if a stream does not match to any category, the matching unit 308 may not add the stream to the category DB 324. In some embodiments, if a stream does not match to any category, the matching unit 308 may add the stream to an “other” category in category DB 324 (S336).

In some embodiments, the filtering unit 306 may transmit the information of the matched category to the stream DB 320 (S338) for reference. Furthermore, a category link may be generated and stored to the stream in stream DB 320 (S340). The category link may be generated according to the information of the match list. For example, the category of the stream may be stored as a link at the stream in stream DB 320. The link may be a linked list in format and connect the stream in stream DB 320 with the category in category DB 324.

In some embodiments, if there are more than one database for storing streams, each database may be linked to the category DB 324 and also be updated dynamically in real-time according to the above procedure. The user may access the category DB 324 for the category of stream (S342). Moreover, the update of the category is triggered or driven by events such as starting a stream, updating a stream, closing a stream or the like. Therefore, it is easier to generate and maintain the category of the stream.

FIG. 13 shows operations of updating or closing the stream in the live streaming system 1. As shown in FIG. 13, the filtering unit 306 may initiate the list of filters in server 10 (S352). The stream DB 320 may further be hooked to the filtering unit 306 (S354). In some embodiments, an operator may update information of the stream (S356). In some embodiments, the operator may be the server 10 itself, an administration staff, the streamer, viewer or the like. The update may be manually or automatically.

Once an update on a stream RI is made by the operator, the category link of the stream R1 may be checked and referred to (S358), and the filtering unit 306 may further update the category according to the category link (S360). The filtering unit 306 may further compare the information of the update with the category link to identify the difference between them (S362). In some embodiments, the difference may indicate whether to update a category, add to another category. remove from one category or the like.

In some embodiments, the filtering unit 306 may also generate a match list according to the comparison and difference above. If there exist new matches between the stream and category, the matching unit 308 may receive the match list (S364) and add the updated streams to the updated category in the category DB 324 accordingly (S366). In some embodiments, if the original category is lost, which means that the updated stream does not match to the original category, the matching unit 308 may also remove the updated stream from the original category in the category DB 324 (S368).

After the update is reflected in the stream and its corresponding category, the filtering unit 306 may transmit the information of the match list to the stream DB 320 (S370). Furthermore, an updated category link may also be generated and stored at the stream in stream DB 320 (S372).

For example, if a streamer changes the hashtag of the streaming room from “dance” to “singer”, an event of updating the streaming room may be triggered. The filtering unit 306 may identify the corresponding category of the streaming room according to the category link. The filtering unit 306 may compare the difference of the original and new category of the stream, and further determine whether to change the category of the stream. The matching unit 308 may further update the category of the stream according to the difference. For example, the matching unit 308 may remove the stream from the category of “dance” and add the stream to the category of “singer”.

Furthermore, the operator may close the stream (S374). For example, the streamer may end the stream voluntarily or the server 10 may terminate the stream due to violation or the like. Once the operator closes the stream, the category link of the stream R1 may be referred to (S376) and the filtering unit 306 may retrieve the category link of the stream for removing category (S378). Furthermore, the filtering unit 306 may remove the stream from the category in the category DB 324 according to the category link (S380). Once the procedure is done, the filtering unit 306 may echo to the stream DB 320 to finish the process (S382).

According to the embodiments, it is easier to generate and maintain the category of the stream. Moreover, the category of streams may be added, updated, modified or removed dynamically without complicated procedure. Therefore, the quality of streams in the live streaming platform may be improved.

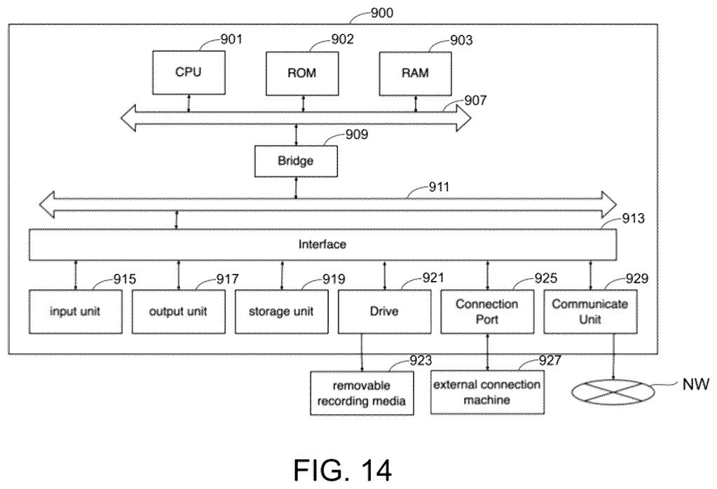

FIG. 14 is a schematic block diagram of computer hardware for carrying out a system configuration and processing according to some embodiments of subject application. The information processing device 900 in FIG. 14 is, for example, is configured to realize the server 10 and the user terminal 20, 30 respectively according to some embodiments of subject application.

The information processing device 900 includes a CPU 901, read only memory (ROM) 903, and random-access memory (RAM) 905. In addition, the information processing device 900 may include a host bus 907, a bridge 909, an external bus 911, an interface 913, an input unit 915, an output unit 917, a storage unit 919, a drive 921, a connection port 925, and a communication unit 929. The information processing device 900 may include imaging devices (not shown) such as cameras or the like. The information processing device 900 may include a processing circuit such as a digital signal processor (DSP) or an application-specific integrated circuit (ASIC), instead of or in addition to the CPU 901.

The CPU 901 functions as an arithmetic processing device and a control device, and controls the overall operation or a part of the operation of the information processing device 900 according to various programs recorded in the ROM 903, the RAM 905, the storage unit 919, or a removable recording medium 923. For example, the CPU 901 controls overall operations of respective function units included in the server 10 and the user terminal 20 and 30 of the above-described embodiment. The ROM 903 stores programs, operation parameters, and the like used by the CPU 901. The RAM 905 transiently stores programs used when the CPU 901 is executed, and parameters that change as appropriate when executing such programs. The CPU 901, the ROM 903, and the RAM 905 are connected with each other via the host bus 907 configured from an internal bus such as a CPU bus or the like. The host bus 907 is connected to the external bus 911 such as a Peripheral Component Interconnect/Interface (PCI) bus via the bridge 909.

The input unit 915 is a device operated by a user such as a mouse, a keyboard, a touchscreen, a button, a switch, and a lever. The input unit 915 may be a device that converts physical quantity to electrical signal such as audio sensor (such as microphone or the like), acceleration sensor, tilt sensor, infrared radiation sensor, depth sensor, temperature sensor, humidity sensor or the like. The input unit 915 may be a remote-control device that uses, for example, infrared radiation and another type of radio waves. Alternatively, the input unit 915 may be an external connection device 927 such as a mobile phone that corresponds to an operation of the information processing device 900. The input unit 915 includes an input control circuit that generates input signals on the basis of information which is input by a user to output the generated input signals to the CPU 901. The user inputs various types of data and indicates a processing operation to the information processing device 900 by operating the input unit 915.

The output unit 917 includes a device that can visually or audibly report acquired information to a user. The output unit 917 may be, for example, a display device such as an LCD, a PDP, and an OLED, an audio output device such as a speaker and a headphone, and a printer. The output unit 917 outputs a result obtained through a process performed by the information processing device 900, in the form of text or video such as an image, or sounds such as audio sounds.

The storage unit 919 is a device for data storage that is an example of a storage unit of the information processing device 900. The storage unit 919 includes, for example, a magnetic storage device such as a hard disk drive (HDD), a semiconductor storage device, an optical storage device, or a magneto-optical storage device. The storage unit 919 stores therein the programs and various data executed by the CPU 901, and various data acquired from an outside.

The drive 921 is a reader/writer for the removable recording medium 923 such as a magnetic disk, an optical disc, a magneto-optical disk, and a semiconductor memory, and built in or externally attached to the information processing device 900. The drive 921 reads out information recorded on the mounted removable recording medium 923, and outputs the information to the RAM 905. The drive 921 writes the record into the mounted removable recording medium 923.

The connection port 925 is a port used to directly connect devices to the information processing device 900. The connection port 925 may be a Universal Serial Bus (USB) port, an IEEE1394 port, or a Small Computer System Interface (SCSI) port, for example. The connection port 925 may also be an RS-232C port, an optical audio terminal, a High-Definition Multimedia Interface (HDMI (registered trademark)) port, and so on. The connection of the external connection device 927 to the connection port 925 makes it possible to exchange various kinds of data between the information processing device 900 and the external connection device 927.

The communication unit 929 is a communication interface including, for example, a communication device for connection to a communication network NW. The communication unit 929 may be, for example, a wired or wireless local area network (LAN), Bluetooth (registered trademark), or a communication card for a wireless USB (WUSB).

The communication unit 929 may also be, for example, a router for optical communication, a router for asymmetric digital subscriber line (ADSL), or a modem for various types of communication. For example, the communication unit 929 transmits and receives signals on the Internet or transmits signals to and receives signals from another communication device by using a predetermined protocol such as TCP/IP. The communication network NW to which the communication unit 929 connects is a network established through wired or wireless connection. The communication network NW is, for example, the Internet, a home LAN, infrared communication, radio wave communication, or satellite communication.

The imaging device (not shown) is a device that images real space using an imaging device such as a charge coupled device (CCD) or a complementary metal oxide semiconductor (CMOS), for example, and various members such as a lens for controlling image formation of a subject image on the imaging device and generates a captured image. The imaging device may capture a still picture or may capture a movie.

The present disclosure of the live streaming system 1 has been described with reference to embodiments. The above-described embodiments have been described merely for illustrative purposes. Rather, it can be readily conceived by those skilled in the art that various modifications may be made in making various combinations of the above-described components or processes of the embodiments, which are also encompassed in the technical scope of the present disclosure.

The procedures described herein, particularly flowchart or those described with a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present disclosure.

In some embodiments, at least a part of the functions performed by the server 10 may be performed by other than the server 10, for example, being performed by the user terminal 20 or 30. In some embodiments, at least a part of the functions performed by the user terminal 20 or 30 may be performed by other than the user terminal 20 or 30, for example, being performed by the server 10. In some embodiments, the rendering of the frame image may be performed by the user terminal of the viewer, the server, the user terminal of the streamer or the like.

Furthermore, the system and method described in the above embodiments may be provided with a computer-readable non-transitory storage device such as a solid-state memory device, an optical disk storage device, or a magnetic disk storage device, or a computer program product or the like. Alternatively, the programs may be downloaded from a server via the Internet.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed but includes another variation and modification that do not disobey the present disclosure, and is the scope covered by the following patent application scope.

### List of Reference Numbers

| | | | |
|---|---|---|---|
| 1 | Live streaming system | 10 | Server |
| 20 | User terminal | 100 | Streaming unit |
| 102 | Video control unit | 104 | Audio control unit |
| 106 | Distribution unit | 108 | UI control unit |
| 200 | Viewing unit | 202 | UI control unit |
| 204 | Rendering unit | 206 | Input unit |
| 30, 30a, 30b | User terminal | 302 | Providing unit |
| 304 | Relay unit | 306 | Filtering unit |
| 308 | Matching unit | 310 | Processing unit |
| 320 | Stream DB | 322 | User DB |
| 324 | filter DB | 326 | Category DB |
| 600 | Screen | 602 | tab object |
| 604 | display zone | | |
| 900 | Information processing | 901 | CPU |
| | device | | |
| 903 | ROM | 905 | RAM |
| 907 | Host bus | 909 | Bridge |
| 911 | External bus | 913 | Interface |
| 915 | Input unit | 917 | Output unit |
| 919 | Storage unit | 921 | Drive |
| 923 | Removable recording | 925 | Connection port |
| | medium | | |
| 927 | External connection | 929 | Communication unit |
| | device | | |
| LS | Live streaming | LV | Streamer |
| NW | Network | SP | Specific portion |
| AU1, AU2 | Viewer | | |
| C1, C2, C3, C4, C0 | category | | |
| F1, F2, F3, F4 | filter | | |
| R1, R2, R3, R4 | raw stream | | |
| S302-S312, S322- | Step | | |
| S342, S352-S382 | | | |
| VD, VD1, VD2 | Video | | |

What is claimed is:

1. A server for managing streams in a live streaming platform, comprising one or a plurality of processors, wherein the one or plurality of processors execute a machine-readable instruction to perform:
receiving a first stream from a user terminal of a user;
determining whether the first stream satisfied a first category; and
adding the first stream into the first category in response to the first stream matching the first category.

2. The server according to claim 1, further comprising:
generating a category link corresponding to the first stream and the first category; and
storing the category link at the first stream.

3. The server according to claim 2, wherein:
the category link is a linked list in format and links the first stream to the first category; and
the first category is accessed from the first stream according to the category link.

4. The server according to claim 2, further comprising:
updating the first stream via the category link; wherein
updating the first stream includes removing the first stream from the first category and/or adding the first stream to a second category.

5. The server according to claim 1, further comprising:
adding the first stream to a third category in response to the first stream not matching to any categories.

6. The server according to claim 1, further comprising:
generating a first filter of the first category; and
hooking the first filter with the first stream; wherein
the first filter and the first stream are hooked by long-polling.

7. The server according to claim 1, further comprising:
retrieving information of the user in response to receiving the first stream; wherein
the information of the user includes unique key, gender, first live stream time, region, hashtag of the user.

8. The server according to claim 1, wherein:
the first stream in the first category includes a parameter of TTL (time to live) identifying a lifespan or lifetime of the first stream in the first category.

9. A method for managing streams in a live streaming platform, comprising:
receiving a first stream from a user terminal of a user;
determining whether the first stream satisfied a first category; and
adding the first stream into the first category in response to the first stream matching the first category.

10. A non-transitory computer-readable medium including program instructions, that when executed by one or more processors, cause the one or more processors to execute:
receiving a first stream from a user terminal of a user;
determining whether the first stream satisfied a first category; and
adding the first stream into the first category in response to the first stream matching the first category.
